(19) United States
(12) Patent Application Publication
(10) Pub. No.: US 2024/0363133 A1
(43) Pub. Date: Oct. 31, 2024

(54) NOISE SUPPRESSION MODEL USING GATED LINEAR UNITS

(71) Applicant: SKYWORKS SOLUTIONS, INC., Irvine, CA (US)

(72) Inventor: Meysam ASGARI, Lake Oswego, OR (US)

(21) Appl. No.: 18/643,582

(22) Filed: Apr. 23, 2024

Related U.S. Application Data
(60) Provisional application No. 63/461,660, filed on Apr. 25, 2023.

(51) Int. Cl. G10L 21/0232; G10L 25/30

(52) U.S. Cl. CPC G10L 21/0232; G10L 25/30

(57) ABSTRACT

Systems, methods, and computer-readable storage devices are disclosed for a noise suppression model using gated linear units. One method includes: receiving audio data including a known noisy acoustic signal, the known noisy acoustic signal including a known clean acoustic signal and at least one known additive noise; transforming the audio data into frequency-domain data; and training a convolutional neural network including at least one gated linear unit (GLU) component based on the frequency-domain data and at least one of a known clean acoustic signal or a known additive noise. The convolutional neural network can output a frequency multiplicative mask that to be multiplied to the frequency-domain data to estimate the known clean acoustic signal.

### CROSS-REFERENCE TO RELATED APPLICATIONS

This application claims priority to U.S. Prov. App. No. 63/461,660 filed Apr. 25, 2023 and entitled “NOISE SUPPRESSION MODEL USING GATED LINEAR UNITS,” which is expressly incorporated by reference herein in its entirety for all purposes.

### BACKGROUND

### Field

The present disclosure relates to audio processing that improves real-time audio quality, speech recognition, and/or speech detection. Specifically, the present disclosure relates to real-time audio processing using machine learning, time-domain information, frequency domain information, and/or parameter tuning to improve enhancement and/or detection of speech and noise in audio data. The real-time audio processing of the present disclosure can substantially reduce a number of parameters while maintaining low latency in processing such that the real-time audio processing can be implemented at a wearable or a portable audio device, such as a headphone, headset, or a pair of earbuds.

### Description of the Related Art

Speech enhancement is one of the corner stones of building robust automatic speech recognition (ASR) and communication systems. The objective of speech enhancement is improvement in intelligibility and/or overall perceptual quality of degraded speech signal using audio signal processing techniques. For example, speech enhancement techniques are used to reduce noise in speech degraded by noise and used for many applications such as mobile phones, voice over IP (VOIP), teleconferencing systems, speech recognition, hearing aids, and wearable audio devices.

Modern speech enhancement systems and techniques are often built using data-driven approaches based on large scale deep neural networks. Due to the availability of high-quality, large-scale data and the rapidly growing computational resources, data-driven approaches using regression-based deep neural networks have attracted much interests and demonstrated substantial performance improvements over traditional statistical-based methods. The general idea of using deep neural networks is not new. However, speech enhancement techniques using deep neural networks have seen limited use due to their model size and heavy computational requirements. For instance, deep neural network-based speech enhancement methods are too cumbersome for use in wearable device applications as such solutions have been too heavy (e.g., having too many parameters to implement) and too slow in latency.

### SUMMARY

According to a number of implementations, the techniques described in the present disclosure relates to a computer-implemented method including: receiving audio data including a known noisy acoustic signal, the known noisy acoustic signal including a known clean acoustic signal and at least one known additive noise; transforming the audio data into frequency-domain data; and training a convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.

In some aspects, the techniques described herein relate to a computer-implemented method, further including: constructing the convolutional neural network, including a plurality of neurons, the plurality of neurons arranged in a plurality of layers including at least one hidden layer, the plurality of layers including a layer including the GLU component, and the plurality of neurons being connected by a plurality of connections.

In some aspects, the techniques described herein relate to a computer-implemented method wherein the layer including GLU component includes a convolutional block that is configured to calculate a first convolutional output and a second convolutional output, the first convolutional output and the second convolutional output calculated based on the frequency-domain data, and a gating block that uses the first convolutional output to partially or completely block the second convolutional output.

In some aspects, the techniques described herein relate to a computer-implemented method wherein a logistic function, including a sigmoid function, receives the first convolutional output and outputs a weight, and the gating block performs an element-wise multiplication with the second convolutional output and the weight.

In some aspects, the techniques described herein relate to a computer-implemented method wherein the convolutional block is configured to zero-pad at least a portion of the frequency-domain data.

In some aspects, the techniques described herein relate to a computer-implemented method wherein the at least one hidden layer of the convolutional neural network includes at least one long short-term memory layer.

In some aspects, the techniques described herein relate to a computer-implemented method wherein a first layer of the plurality of layers is configured to encode frequencies in the frequency-domain data into a lower-dimension feature space, and a second layer of the plurality of layers is configured to decode feature space to high-dimension and output the frequency multiplicative mask.

In some aspects, the techniques described herein relate to a computer-implemented method, further including providing the trained convolutional neural network to a wearable or portable audio device wherein the audio device is capable of receiving real-time audio data, transforming the real-time audio data into real-time frequency-domain data, outputting a real-time frequency multiplicative mask using the trained convolutional neural network and the real-time audio data, and applying the real-time frequency multiplicative mask to the real-time frequency-domain data.

In some aspects, the techniques described herein relate to a computer-implemented method wherein the audio data includes a plurality of frames wherein the transforming the audio data into frequency-domain data further includes calculating spectral features for a plurality of frequency bins based on the plurality of frames.

In some aspects, the techniques described herein relate to a computer-implemented method, further including receiving a test data set, the test data set including audio data with unseen noise, and evaluating the trained convolutional neural network using the received test data set.

In some aspects, the techniques described herein relate to a computer-implemented method wherein the frequency multiplicative mask is at least one of a complex ratio mask or an ideal ratio mask.

In some aspects, the techniques described herein relate to a computer-implemented method wherein the audio data is synthetic audio data with a known noisy acoustic signal and at least one of a known clean acoustic signal or a known additive noise.

In some aspects, the techniques described herein relate to a computer-implemented method wherein the known noisy acoustic signal is a known noisy speech signal and the known clean acoustic signal is a known clean speech signal.

In some aspects, the techniques described herein relate to a system including: a data storage device that stores instructions for improved real-time audio processing; and one or more processors configured to execute the instructions to perform a method including: receiving audio data including a known noisy acoustic signal, the known noisy acoustic signal including a known clean acoustic signal and at least one known additive noise; transforming the audio data into frequency-domain data; and training a convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.

In some aspects, the techniques described herein relate to a system wherein the one or more processors is further configured to execute the instructions to perform the method further including constructing the convolutional neural network, including a plurality of neurons, the plurality of neurons arranged in a plurality of layers including at least one hidden layer, the plurality of layers including a layer including the GLU component, and the plurality of neurons being connected by a plurality of connections.

In some aspects, the techniques described herein relate to a system wherein the layer including GLU component includes a convolutional block that is configured to calculate a first convolutional output and a second convolutional output, the first convolutional output and the second convolutional output calculated based on the frequency-domain data, and a gating block that uses the first convolutional output to partially or completely block the second convolutional output.

In some aspects, the techniques described herein relate to a system wherein a logistic function, including a sigmoid function, receives the first convolutional output and outputs a weight, and the gating block performs an element-wise multiplication with the second convolutional output and the weight.

In some aspects, the techniques described herein relate to a system wherein the at least one hidden layer of the convolutional neural network includes at least one long short-term memory layer.

In some aspects, the techniques described herein relate to a system wherein a first layer of the plurality of layers is configured to encode frequencies in the frequency-domain data into a lower-dimension feature space, and a second layer of the plurality of layers is configured to decode feature space to high-dimension and output the frequency multiplicative mask.

In some aspects, the techniques described herein relate to a computer-readable storage device storing instructions that, when executed by one or more processors, cause the one or more processors to perform a method including: receiving audio data including a known noisy acoustic signal, the known noisy acoustic signal including a known clean acoustic signal and at least one known additive noise; transforming the audio data into a frequency-domain data; constructing a convolutional neural network, including a plurality of neurons, the plurality of neurons arranged in a plurality of layers including at least one hidden layer, the plurality of layers including a layer including a GLU component, and the plurality of neurons being connected by a plurality of connections; and training the convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a system that includes a wearable audio device in communication with a host device, where the wearable audio device includes an audio amplifier circuit.

FIG. 2 shows that the wearable audio device of FIG. 1 can be implemented as a device configured to be worn at least partially in an ear canal of a user.

FIG. 3 shows that the wearable audio device of FIG. 1 can be implemented as part of a headphone configured to be worn on the head of a user, such that the audio device is positioned on or over a corresponding ear of the user.

FIG. 4 shows that in some embodiments, the audio amplifier circuit of FIG. 1 can include a number of functional blocks.

FIGS. 4A-4B illustrate end-to-end models based on deep neural networks for speech enhancement, according to embodiments of the present disclosure.

FIGS. 5A-5B illustrate example ultra-small noise suppression model architectures, according to embodiments of the present disclosure.

FIG. 6 illustrates a gated linear unit, according to embodiments of the present disclosure.

FIG. 7 illustrates a speech enhancement framework, according to embodiments of the present disclosure.

FIGS. 8A-8B show some evaluative metrics related to speech enhancement provided by the present disclosure.

FIG. 9 is a flowchart illustrating a method for improved real-time audio processing, according to embodiments of the present disclosure.

### DETAILED DESCRIPTION OF SOME EMBODIMENTS

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

The headings provided herein, if any, are for convenience only and do not necessarily affect the scope or meaning of the claimed invention.

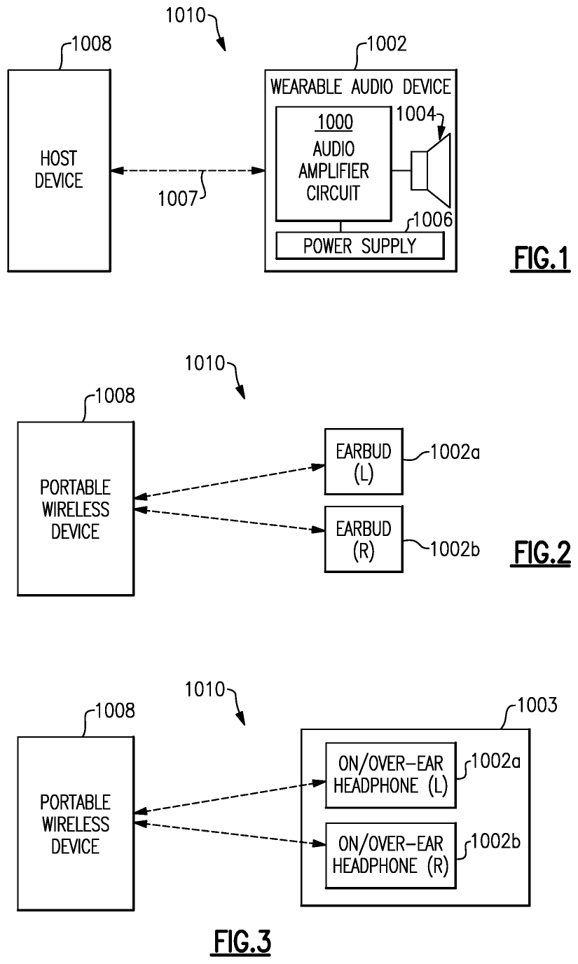

FIG. 1 depicts a system 1010 that includes a wearable audio device 1002 in communication with a host device 1008. Various embodiments of the present disclosure may be implemented at the wearable audio device 1002 or the host device 1008. A wearable audio device can be worn by a user to allow the user to enjoy listening of an audio content stream being played by a mobile device. Such an audio content stream may be provided from the mobile device to the wearable audio device through, for example, a short-range wireless link. Once received by the wearable audio device, the audio content stream can be processed by one or more circuits to generate an output that drives a speaker to generate sound waves representative of the audio content stream.

Such communication, depicted as 1007 in FIG. 1, can be supported by, for example, a wireless link such as a short-range wireless link in accordance with a common industry standard, a standard specific for the system 1010, or some combination thereof. In some embodiments, the wireless link 1007 includes digital format of information being transferred from one device to the other (e.g., from the host device 1008 to the wearable audio device 1002).

In FIG. 1, the wearable device 1002 is shown to include an audio amplifier circuit 1000 that provides an electrical audio signal to a speaker 1004 based on a digital signal received from the host device 1008. Such an electrical audio signal can drive the speaker 1004 and generate sound representative of a content provided in the digital signal, for a user wearing the wearable device 1002.

In FIG. 1, the wearable device 1002 is a wireless device; and thus typically includes its own power supply 1006 including a battery. Such a power supply can be configured to provide electrical power for the audio device 1002, including power for operation of the audio amplifier circuit 1000. It is noted that since many wearable audio devices have small sizes for user-convenience, such small sizes places constraints on power capacity provided by batteries within the wearable audio devices.

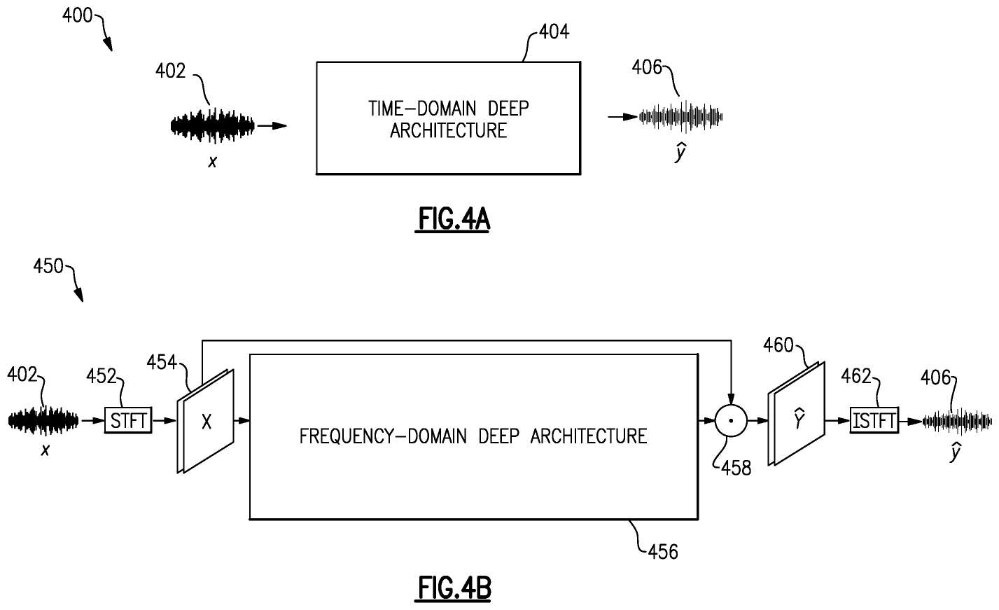

In some embodiments, the host device 1008 can be a portable wireless device such as, for example, a smartphone, a tablet, an audio player, etc. It will be understood that such a portable wireless device may or may not include phone functionality such as cellular functionality. In such an example context of a portable wireless device being a host device, FIGS. 2 and 3 show more specific examples of wearable audio devices 1002 of FIG. 1.

For example, FIG. 2 shows that the wearable audio device 1002 of FIG. 1 can be implemented as a device (1002a or 1002b) configured to be worn at least partially in an ear canal of a user. Such a device, commonly referred to as an earbud, is typically desirable for the user due to compact size and light weight.

In the example of FIG. 2, a pair of earbuds (1002a and 1002b) can be provided-one for each of the two ears of the user—and each earbud can include its own components (e.g., audio amplifier circuit, speaker and power supply) described above in reference to FIG. 1. In some embodiments, such a pair of earbuds can be operated to provide, for example, stereo functionality for left (L) and right (R) ears.

In another example, FIG. 3 shows that the wearable audio device 1002 of FIG. 1 can be implemented as part of a headphone 1003 configured to be worn on the head of a user, such that the audio device (1002a or 1002b) is positioned on or over a corresponding ear of the user. Such a headphone is typically desirable for the user due to audio performance.

In the example of FIG. 3, a pair of audio devices (1002a and 1002b) can be provided-one for each of the two ears of the user. In some embodiments, each audio device (1002a or 1002b) can include its own components (e.g., audio amplifier circuit, speaker and power supply) described above in reference to FIG. 1. In some embodiments, one audio device (1002a or 1002b) can include an audio amplifier circuit that provides outputs for the speakers of both audio devices. In some embodiments, the pair of audio devices 1002a, 1002b of the headphone 1003 can be operated to provide, for example, stereo functionality for left (L) and right (R) ears.

In audio applications, wearable or otherwise, additive background noise contaminating the target speech negatively impacts the quality of speech communication and results in reduced intelligibility and perceptual quality. It may also degrade the performance of automatic speech recognition (ASR) systems.

Traditionally, speech enhancement methods aimed at suppressing the noise component from the contaminated speech using conventional signal processing algorithms such as Wiener filtering. However, their performances are very sensitive to the characteristics of the background noise and greatly decrease in low signal-to-noise (SNR) conditions with non-stationary noises. Today, various noise suppression methods based on deep neural networks (DNNs) show some promise in overcoming the challenges of the conventional signal processing algorithms. The proposed networks learn a complex non-linear function to recover target speech from noisy speech.

FIGS. 4A-4B illustrate end-to-end models 400, 450 based on deep neural networks for speech enhancement, according to embodiments of the present disclosure. Both models 400, 450 may receive an input acoustic signal (e.g., input audio waveform) containing additive noise component, process the input acoustic signal to filter the noise component, and provide an output acoustic signal (e.g., output audio waveform) free of noise or with suppressed noise component. In some instances, the input acoustic signal may be a noisy speech 402 and the output acoustic signal may be a target speech (e.g., clean speech or estimated speech) 406.

The DNN based noise suppression methods can be broadly categorized into (i) time-domain methods, (ii) frequency-domain methods, and (iii) time-frequency domain (hybrid) methods. FIG. 4A illustrates a time-domain end-to-end model 400 and FIG. 4B illustrates a frequency-domain end-to-end model 450. Both models 400, 450 can be trained in a supervised fashion with real or synthesized noisy speech 402 as the input and clean speech (e.g., target speech or estimated speech) 406 as an output of the network.

The time-domain end-to-end model 400 can map the noisy speech 402 to the clean speech 406 through a time-domain deep architecture 404. During training, various parameters in a time-domain deep architecture 404 can be tuned, such as by adjusting various weights and biases. The trained time-domain deep architecture 404 can function as a “filter” in a sense that the time-domain deep architecture 404, when properly trained and implemented, can remove the additive noise from the noisy speech 402 and provide the clean speech 406.

Similarly, the frequency-domain end-to-end model 450 can map the noisy speech 402 to the clean speech 406 through a frequency-domain deep architecture 456. Instead of directly mapping the noisy speech 402 to the clean speech 406 as illustrated in the time-domain end-to-end model 400, the frequency-domain methods can extract input spectral features 454 from the noisy speech 402 and provide the input spectral features 454 to the frequency-domain deep architecture 456. The input spectral features 454 may be extracted using various types of Fourier transform 452 (e.g., short-time Fourier transform (STFT), discrete-time Fourier transform (DFT), fast Fourier transform (FFT), or the like) that transforms time-domain signals into frequency-domain signals. In some instances, the input spectral features 454 can be associated with a set of frequency bins. For example, when the noisy speech 402 sample rate is 100 Hz and FFT size is 100, then there will be 100 points between [0 100) Hz that divides the entire 100 Hz range into 100 intervals (e.g., 0-1 Hz, 1-2 Hz, . . . , 99-100 Hz). Each such small interval can be a frequency bin.

During training, various parameters in the frequency-domain deep architecture 456 can be tuned, such as by adjusting various weights and biases to determine a frequency multiplicative mask that can be applied to the input spectral features 454 to remove the additive noise. For example, the frequency-domain end-to-end model 450 illustrates an operation (e.g., multiplication) 458 that takes in as inputs the input spectral features 454 and the frequency multiplicative mask determined through the training process. In some instances, the frequency multiplicative mask can be a phase-sensitive mask. For example, the frequency multiplicative mask can be a complex ratio mask that contains the real and imaginary parts of the complex spectrum. That is, the frequency-domain deep architecture 456 may include complex-valued weights and complex-valued neural networks.

The output spectral features 460 that results from the operation 458 can include input spectral features 454 that have attenuated the noise power across the frequency bins. The output spectral features 460 can further go through an inverse Fourier transform 462 to ultimately provide the clean speech 406.

Generally, the time-domain end-to-end model 450 that directly (e.g., without time-frequency domain transform) estimate clean speech waveforms through end-to-end training can suffer from challenges arising from modeling long sequences as the long sequences often require very deep architecture with many layers. Such deep convolutional layers can involve too many parameters. More particularly, when designing models for real-time speech enhancement in a mobile or wearable device, it may be impractical to apply too many layers or non-causal structures.

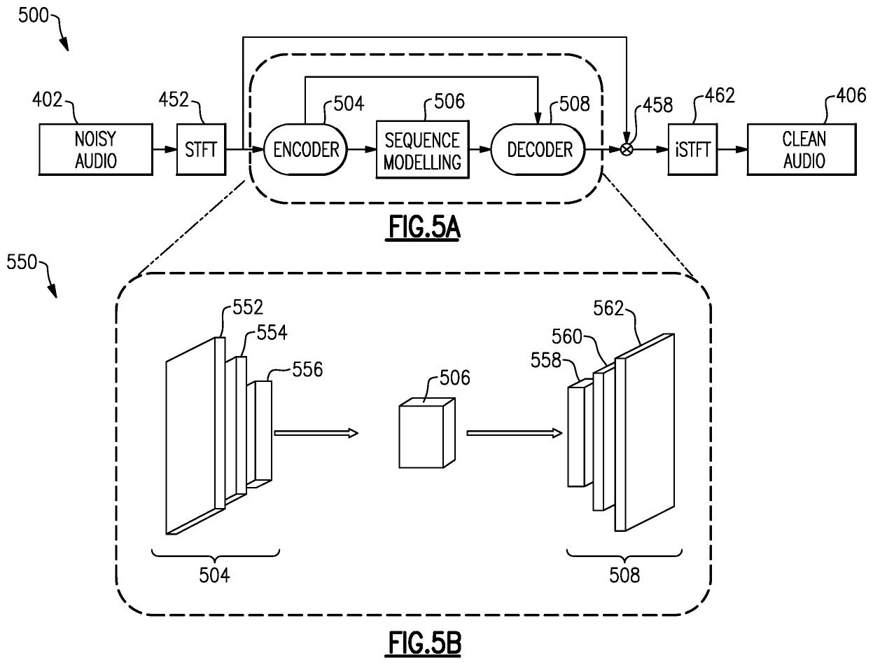

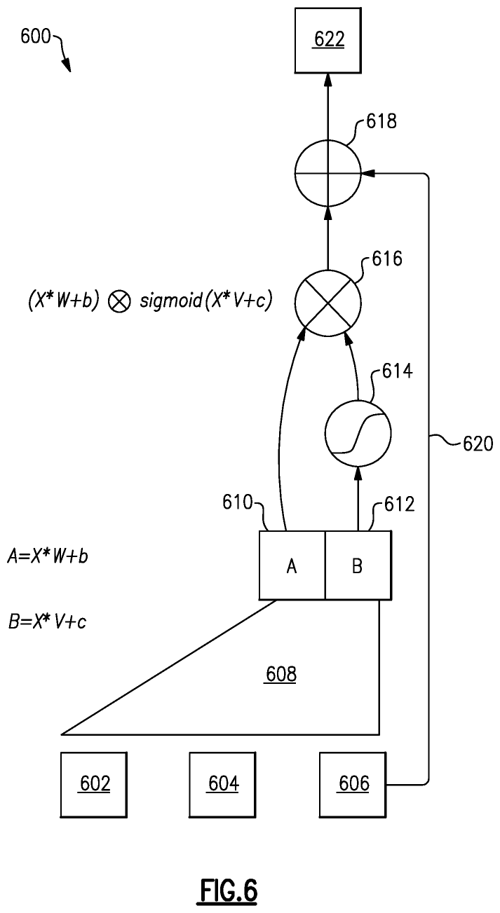

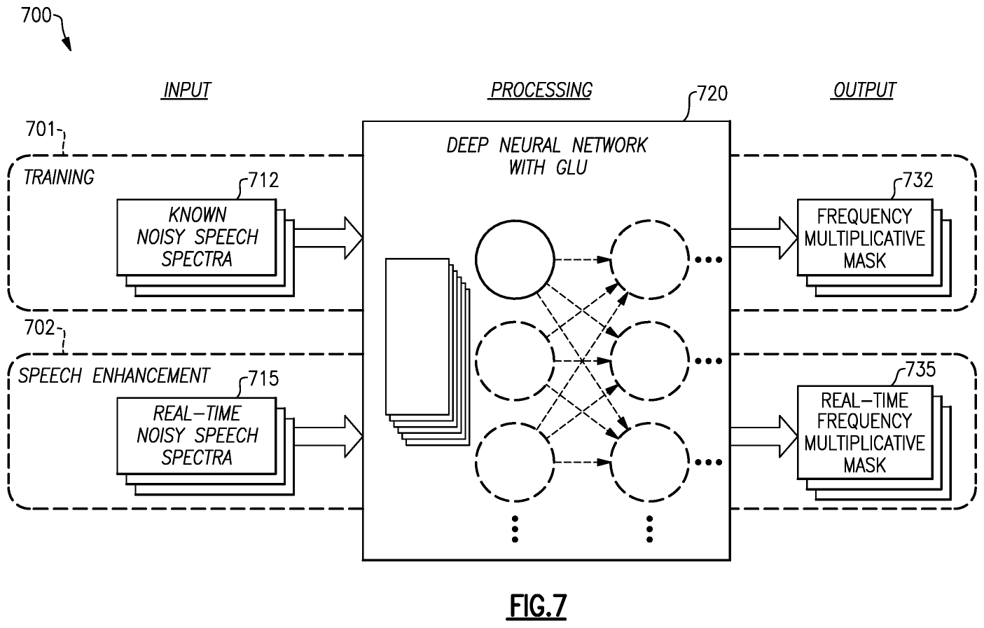

In some instances, the time-frequency (T-F) domain methods (not shown) can combine some aspects of time-domain methods and frequency-domain methods to provide an improved noise cancelling capability with reduced parameter count. T-F domain methods can, similar to the frequency-domain methods, extract spectral features of a frame of acoustic signal using the transform 452. It was described that the frequency-domain method 450 can train a deep neural architecture 456 with the extracted spectral features 454, or local features, of each frame. In addition to the local spectral features, the T-F method can additionally model variations of the spectrum over time between consecutive frames. For example, the T-F method may take advantage of temporal information in the acoustic signal using one or more long-short term memory (LSTM) layers. A new end-to-end model for speech enhancement that provides sufficient noise filtering capability with fewer parameters will be described in greater detail with respect to FIGS. 5A-5B.

FIG. 5A illustrates an ultra-small noise suppression model architecture 500, according to embodiments of the present disclosure. The model architecture can build on the frequency-domain end-to-end model 450 of FIG. 4B. Specifically, the ultra-small noise suppression model architecture 500 can include (i) an encoder block 504, (ii) a sequence modelling block 506, and (iii) a decoder block 508. The model architecture 500 can include a neural network, including a plurality of neurons, the plurality of neurons arranged in a plurality of layers, including at least one hidden layer, and being connected by a plurality of connections. In some implementations, the model architecture may construct the neural network as a convolutional neural network.

The encoder block 504 can map frequencies into a lower-dimension feature space. The encoder block 504 can convert speech waveform into effective representations with one or more 2-D convolutional (Conv2D) layers. The Conv2D layers can extract local patterns from noisy speech spectrogram and reduce the feature resolution. In some instances, real and imaginary parts of complex spectrogram of the noisy speech 402 can be sent to the encoder block 504 as two streams. Additionally, in some implementations, the encoder block 504 can provide skip connections between the encoder block 504 and the decoder block 508 that pass some detailed information of the noisy speech spectrogram.

Particularly, the encoder block 504 can include one or more gated convolutional layers to encode frequencies. In some implementations, the gated convolutional layers can include one or more gated linear units (GLUs). Each of the GLU can provide an extra output that contains a ‘gate’ that control what or how much information from a normal output is passed to the next layer, which may also be a gated convolutional layer having GLUs. The GLU will be described in greater detail in relation to FIG. 6.

The sequence modeling block 506 can model long-term dependencies to leverage contextual information in time. Here, some additional layers and operations can be provided to further configure the ultra-small noise suppression model architecture 500. For example, one or more LSTM layers, normalization layers, or computational functions (e.g., rectified linear unit (ReLU) activation function, SoftMax function, etc.) can be added to better capture variations of the extracted and convoluted spectrum over time between consecutive frames. Specifically, the LSTM layers can extract temporal information along the time axis.

The decoder block 508 can map from feature space to high-dimension frequency mask. The decoder block 508 can use transposed convolutional layers (Conv2DTrans) to restore low-resolution features to the original size, forming a symmetric structure with the encoder block 504. In some implementations, the outputs from the decoder block 508 can include real and imaginary parts of complex spectrogram as two streams. As illustrated, the ultra-small noise suppression model architecture 500 can include one or more skip connections between the encoder block 504 and the decoder block 508.

FIG. 5B illustrates an example deep architecture 550 of the ultra-small noise suppression model architecture 500 in greater detail, according to embodiments of the present disclosure. As part of the encoder block 504, the deep architecture can include any number of Conv2D layers to map frequencies into a lower-dimension feature space and any number of Conv2DTrans layers to map from feature space to high-dimension frequency mask. In the example deep architecture 550, there are three Conv2D layers 552, 554, 556 and three Conv2DTrans layers 558, 560, 562. It will be understood that there could be fewer or more layers.

FIG. 6 illustrates a gated linear unit (GLU) 600, according to embodiments of the present disclosure. The Conv2D layers 552, 554, 556 and Conv2DTrans layers 558, 560, 562 can include and use the GLU 600. That is, the Conv2D layers 552, 554, 556 can be convolutional layers using GLUs and the Conv2DTrans layers 558, 560, 562 can similarly be convolutional transpose layers using GLUs. Each GLU 600 can be composed of (i) a convolutional block 608 that produces two separate convolutional outputs (a first convolutional output A 610 and a second convolutional output B 612), and (ii) a gating block that uses one convolutional output B 612 to gate (e.g., partially or completely block) the other output A 610.

The first convolutional output A 610 can be computed based on a formula A=X*W+b, where W is a convolutional filter and b is a bias vector. Similarly, the second convolutional output B 612 can be computed based on a formula B=X*V+c, where V and c are different convolutional filter and bias vector, respectively. The two outputs of the convolutional block are A 610 and B 612. The output B 612 can be further processed with a logistic function, such as a sigmoid function which will be used in these descriptions. For example, a sigmoid of the output B 612 can be calculated to provide sigmoid (B) 614.

Then, A 610 and sigmoid (B) 614 can be passed to a gating block which element-wise multiplies A 610 and sigmoid (B) 614 to provide AØsigmoid (B) 616 or, equivalently, (X*W+b)Øsigmoid (X*V+c). Here, B 612 controls what information from A 610 is passed up to the next layer as a gated output 622. That is, B 612 functions as a weight that adjusts the first output A 610. The gating mechanism is important because it allows selection of spectral features that are important for predicting the next spectral feature, and provides a mechanism to learn and pass along just the relevant information. For example, when sigmoid (B) 614 is close to 0 (zero), the multiplicative result of the gating block will be close to zero and, thus, substantially gates/blocks the first output A 610 from the gated output 622. In contrast, when sigmoid (B) 614 is close to 1 (one), the multiplicative result of the gating block will be open and substantially pass along A 610 to the gated output 622.

In the example deep architecture 550 of FIG. 5B, the GLU 600 can remove a need for an activation function like ReLU. That is, the gating mechanism can provide the layer with non-linear capabilities while providing a linear path for the gradient during backpropagation (thereby diminishing the vanishing gradient problem), which is a function typically associated with ReLU.

In some implementations, the GLU 600 may include one or more residual skip connections 620 to between layers. The residual skip connections 620 can help minimize the vanishing gradient problem, thereby allowing networks to be built with more layers. In FIG. 6, for example, input to the layer (X) is added to the first convolutional output A 610 at an addition block, after A 610 is gated by the second convolutional output B 612, to provide (X+ (AØsigmoid (B) 618, or equivalently, X+(X*W+b) Øsigmoid (X*V+c).

The convolutional layers using GLU can be stacked. For example, the example deep architecture 550 of FIG. 5B illustrates a three-stack layers 552, 554, 556 for the encoder block 504 and a three-stack layers 558, 560, 562 for the decoder block 508. It is noted the numbers of layers are selected for illustrative purposes only and any number of layers may be used.

### Training and Implementation

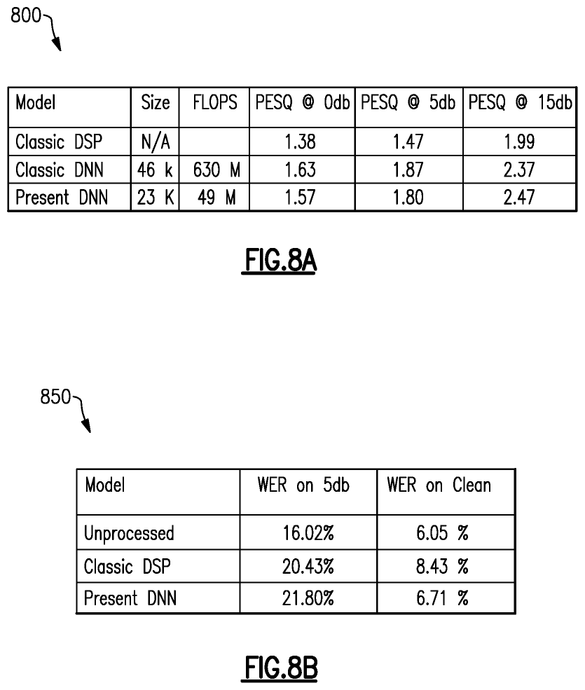

FIG. 7 illustrates a speech enhancement framework 700, according to embodiments of the present disclosure. The speech enhancement framework 700 may be embodied in certain control circuitry, including one or more processors, data storage devices, connectivity features, substrates, passive and/or active hardware circuit devices, chips/dies, and/or the like. Specifically, the speech enhancement framework can be small enough in computation and memory footprint that the framework 700 can be implemented in or for a wearable, portable, or other embedded audio devices. For example, the framework 700 may be embodied in the wearable audio device 1002 or the host device 1008 shown in FIGS. 1-3 and described above. The framework 700 may employ machine learning functionality to predict a frequency multiplicative mask that can attenuate noise power from a noisy acoustic signal to provide clean acoustic signal.

The framework 700 may be configured to operate on certain acoustic-type data structures, such as speech data with additive noise, which may be an original sound waveform or synthetic sound waveform constructed. Such input data may be transformed using a Fourier transform and associated with frequency bins. The transformed input data can be operated on in some manner by certain deep neural network with GLUs 720 associated with a processing portion of the framework 700. The framework 700 can involve a training process 701 and a speech enhancement process 702.

With respect to the training process 701, the deep neural network with GLUs 720 may be trained according to known noisy speech spectra 712 and frequency multiplicative mask 732 corresponding to the respective known noisy speech spectra 712 as input/output pairs. The frequency multiplicative mask 732 may be a complex mask, an ideal ratio mask, or the like. The known noisy speech spectra 712 is known in the sense that known clean speech signal (or known additive noise) associated with the known noisy speech spectra 712 is known such that training can compare the clean speech signal and output signals resulting from application of the frequency multiplicative mask 732 to the known noisy speech spectra 712. During training, which may be supervised training, the deep neural network with GLUs 720 can tune one or more parameters (e.g., weights, biases, etc.) to correlate the input/output pairs.

Referring back to FIG. 4B, while not shown in the framework 700, the known noisy speech spectra 712 can be spectral features of the noisy speech 402 that has been transformed. That is, the known noisy speech spectra 712 can correspond to the input spectra features 454 generated from Fourier-transforming the noisy speech 402. Like the operation 458, the frequency multiplicative mask 732 can be multiplied to the known noisy speech spectra 712 to provide output spectral features 460 that corresponds to a Fourier-transform of the clean speech 406 in FIG. 4B. During training, such output spectral features 460 can be compared to known clean speech spectra associated with the known noisy speech spectra 712 to tune the deep neural network 720.

The network 720 may include a plurality of neurons (e.g., layers of neurons, as shown in FIG. 7) corresponding to the parameters. The network 720 may include any number of convolutional layers, wherein more layers may provide for identification of higher-level features. The network 720 may further include one or more pooling layers, which may be configured to reduce the spatial size of convolved features, which may be useful for extracting invariant features. Once the parameters are sufficiently tuned to provide a frequency multiplicative mask 732 that satisfactorily suppresses noise component from the noisy speech 701, the parameters can be set. That is, the frequency multiplicative mask 732 can be set.

With respect to the speech enhancement process 702, the trained version of the deep neural network with GLUs 720 having the set parameters can be implemented in a system or a device, such as the system 1010, wireless device 1008, or audio device 1002. When implemented, the trained version of the network 720 can receive a real-time noisy speech spectra 715 and provide a real-time frequency multiplicative mask 735 using the trained version. The real-time frequency multiplicative mask 735 can be applied (e.g., multiplied as illustrated with the operation 458 of FIG. 5A) to the real-time noisy speech spectra 715 to generate a noise-suppressed spectra of a clean speech signal.

### Model Evaluation

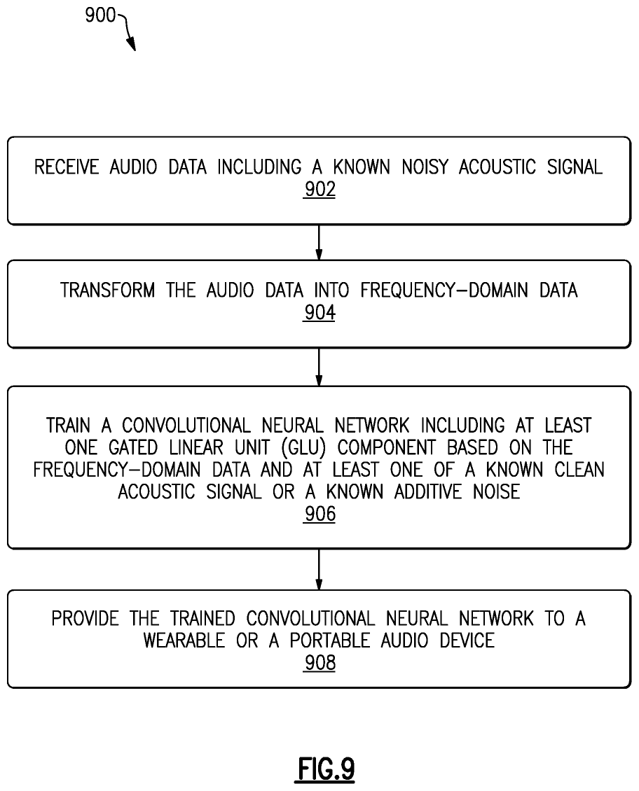

FIGS. 8A-8B show some evaluative metrics related to speech enhancement provided by the present disclosure. A first table 800 lists parameter size, floating point operations per second required for each iteration (FLOPS), Perceptual Evaluation of Speech Quality (PESQ; 1-5 rating, higher is better) at 5 dB noise level and PESQ at 15 dB noise level for different noise suppression techniques. “Classic DSP” is a speech enhancement technique without a deep neural network, “Classic DNN” is available deep neural network-based techniques, and “Present DNN” is for the noise suppression presently disclosed. The metrics may be approximate and not exact.

As shown, the “Present DNN” outperforms the “Classic DSP” and provides substantially similar PESQ performance compared to “Classic DNN.” Importantly, the “Present DNN” achieves such performance at half the parameter size (e.g., 46k to 23k) and at more than one-twelfth of computational power (630M FLOPS to 49M FLOPS). As described, although deep neural network-based models can outperform classic approaches, implementation of the models in wearable, portable, or embedded audio devices have been challenging due to their requirements of vast computational complexity and memory footprint. However, the “Present DNN” offers sufficient performance with much smaller computational complexity and memory footprint. Accordingly, the “Present DNN” can enable deep neural network-based speech enhancement in a wearable, portable, and embedded audio devices.

A second table 850 lists “word error rate” (WER) on 5 dB noisy condition and clean condition. The metrics may be approximate and not exact. WER is a metric that can measure presence, or a degree thereof, of sound artifacts produced in an output of a noise suppression model. For instance, the output of noise suppression model may be fed into ASR systems for downstream applications, such as voice commands. The performance of ASR systems in a setting may be altered due to sound artifacts created by the noise suppression model. Respective WERs of processed and unprocessed outputs can be compared to indicate a degree of sound artifacts produced. The closer the WERs of the processed output to unprocessed output can indicate fewer sound artifacts produced which, in turn, can indicate a noise suppression model that impacts performance of the ASR systems less.

In the clean condition, the “Present DNN” may degrade WER by 11% (e.g., the quantity of 6.71% minus 6.05%, divided by 6.05%) compared to “Classic DSP” with 40% degradation (e.g., the quantity of 8.43% minus 6.05%, divided by 6.05%). In 5 dB noisy condition, the “Present DNN” may degrade WER by 36% (e.g., the quantity of 21.80% minus 16.02%, divided by 16.02%) compared to “Classic DSP” with 27% degradation (e.g., the quantity of 20.43% minus 16.02%, divided by 16.02%). Considering the benefits of reduced parameter count and reduced computational complexity, the WERs indicate a speech enhancement DNN model that provides a significant improvement compared to the presently available technologies.

### Speech Enhancement Using Deep Neural Network Methods and Operations

FIG. 9 is a flowchart illustrating a method 900 for improved real-time audio processing, according to embodiments of the present disclosure. More particularly, the method 900 involves training a noise suppression model architecture (e.g., the ultra-small noise suppression model architecture 500 of FIG. 5A) and operating the model architecture in real-time. As FIG. 9 shows, the method 900 may begin at block 902.

At block 902, audio data including a known noisy acoustic signal can be received. In some instances, the audio data may include a plurality of frames having a plurality of frequency bins. The audio data can be part of a training data set and the audio data can have separately known clean acoustic signal and/or known additive noise. The audio data can be known noisy acoustic signal or synthetic acoustic signal.

At block 904, the audio data can be transformed into frequency-domain data if the audio data is in the time-domain. Various types of Fourier transforms or its equivalents can be used to transform the audio data into the frequency-domain data.

At block 906, a convolutional neural network including at least one GLU can be trained based on the frequency-domain data of the audio data and (i) the known clean acoustic signal or (ii) the known additive noise. In some implementations, the training can be conducted in a supervised manner with by iteratively tuning parameters of the convolutional neural network such that a known input matches or substantially matches to known output. For example, the parameters can be tuned such that the convolutional neural network substantially maps frequency-domain representations of the known noisy acoustic signal to frequency-domain representations the known clean acoustic signal. As another example, where the convolutional neural network is configured to output a frequency multiplicative mask, the parameters can be tuned such that applying the frequency multiplicative mask to frequency-domain representations of the known acoustic signal would substantially result in frequency-domain representation of the clean acoustic signal.

In some implementations, the convolutional neural network may be configured to output the known clean signal acoustic signal, the frequency multiplicative mask, or both. Optionally, the trained neural network model can be evaluated with a test data set including audio data with unseen noise.

At block 908, the trained convolutional neural network can be provided to a wearable or a portable audio device. For example, the trained convolutional neural network. The audio device can receive real-time audio data and transform the real-time audio data into real-time frequency data. The audio device can use the trained convolutional neural network to determine a real-time frequency multiplicative mask by providing the received real-time audio data to the trained convolutional neural network. The audio device can apply the real-time frequency multiplicative mask to the real-time frequency domain audio to obtain clean audio data in real-time.

### Additional Embodiments

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A computer-implemented method comprising:
receiving audio data including a known noisy acoustic signal, the known noisy acoustic signal including a known clean acoustic signal and at least one known additive noise;
transforming the audio data into frequency-domain data; and
training a convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.

2. The computer-implemented method of claim 1, further comprising:
constructing the convolutional neural network, including a plurality of neurons, the plurality of neurons arranged in a plurality of layers including at least one hidden layer, the plurality of layers including a layer including the GLU component, and the plurality of neurons being connected by a plurality of connections.

3. The computer-implemented method of claim 2 wherein the layer including GLU component includes a convolutional block that is configured to calculate a first convolutional output and a second convolutional output, the first convolutional output and the second convolutional output calculated based on the frequency-domain data, and a gating block that uses the first convolutional output to partially or completely block the second convolutional output.

4. The computer-implemented method of claim 3 wherein a logistic function, including a sigmoid function, receives the first convolutional output and outputs a weight, and the gating block performs an element-wise multiplication with the second convolutional output and the weight.

5. The computer-implemented method of claim 3 wherein the convolutional block is configured to zero-pad at least a portion of the frequency-domain data.

6. The computer-implemented method of claim 2 wherein the at least one hidden layer of the convolutional neural network includes at least one long short-term memory layer.

7. The computer-implemented method of claim 2 wherein a first layer of the plurality of layers is configured to encode frequencies in the frequency-domain data into a lower-dimension feature space, and a second layer of the plurality of layers is configured to decode feature space to high-dimension and output the frequency multiplicative mask.

8. The computer-implemented method of claim 1, further comprising providing the trained convolutional neural network to a wearable or portable audio device wherein the audio device is capable of receiving real-time audio data, transforming the real-time audio data into real-time frequency-domain data, outputting a real-time frequency multiplicative mask using the trained convolutional neural network and the real-time audio data, and applying the real-time frequency multiplicative mask to the real-time frequency-domain data.

9. The computer-implemented method of claim 1 wherein the audio data includes a plurality of frames wherein the transforming the audio data into frequency-domain data further includes calculating spectral features for a plurality of frequency bins based on the plurality of frames.

10. The computer-implemented method according to claim 1, further comprising receiving a test data set, the test data set including audio data with unseen noise, and evaluating the trained convolutional neural network using the received test data set.

11. The computer-implemented method of claim 1 wherein the frequency multiplicative mask is at least one of a complex ratio mask or an ideal ratio mask.

12. The computer-implemented method of claim 1 wherein the audio data is synthetic audio data with a known noisy acoustic signal and at least one of a known clean acoustic signal or a known additive noise.

13. The computer-implemented method of claim 1 wherein the known noisy acoustic signal is a known noisy speech signal and the known clean acoustic signal is a known clean speech signal.

14. A system comprising:
a data storage device that stores instructions for real-time audio processing; and
one or more processors configured to execute the instructions to perform a method comprising:
receiving audio data including a known noisy acoustic signal, the known noisy acoustic signal including a known clean acoustic signal and at least one known additive noise;
transforming the audio data into frequency-domain data; and
training a convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.

15. The system of claim 14 wherein the one or more processors is further configured to execute the instructions to perform the method further comprising constructing the convolutional neural network, including a plurality of neurons, the plurality of neurons arranged in a plurality of layers including at least one hidden layer, the plurality of layers including a layer including the GLU component, and the plurality of neurons being connected by a plurality of connections.

16. The system of claim 15 wherein the layer including GLU component includes a convolutional block that is configured to calculate a first convolutional output and a second convolutional output, the first convolutional output and the second convolutional output calculated based on the frequency-domain data, and a gating block that uses the first convolutional output to partially or completely block the second convolutional output.

17. The system of claim 16 wherein a logistic function, including a sigmoid function, receives the first convolutional output and outputs a weight, and the gating block performs an element-wise multiplication with the second convolutional output and the weight.

18. The system of claim 15 wherein the at least one hidden layer of the convolutional neural network includes at least one long short-term memory layer.

19. The system of claim 15 wherein a first layer of the plurality of layers is configured to encode frequencies in the frequency-domain data into a lower-dimension feature space, and a second layer of the plurality of layers is configured to decode feature space to high-dimension and output the frequency multiplicative mask.

20. A computer-readable storage device storing instructions that, when executed by one or more processors, cause the one or more processors to perform a method comprising:
receiving audio data including a known noisy acoustic signal, the known noisy acoustic signal including a known clean acoustic signal and at least one known additive noise;
transforming the audio data into a frequency-domain data;
constructing a convolutional neural network, including a plurality of neurons, the plurality of neurons arranged in a plurality of layers including at least one hidden layer, the plurality of layers including a layer including a GLU component, and the plurality of neurons being connected by a plurality of connections; and
training the convolutional neural network including at least one gated linear unit (GLU) component based on the frequency-domain data and at least one of the known clean acoustic signal or the known additive noise, the convolutional neural network outputs a frequency multiplicative mask that to be multiplied to the frequency-domain data to estimate the known clean acoustic signal.
